(19) United States
(12) Patent Application Publication
(10) Pub. No.: US 2004/0011649 A1
(43) Pub. Date: Jan. 22, 2004

(54) Method and device for injecting a sample in an electrophoresis capillary

(76) Inventors: Gilbert Gauguet, Gif-Sur-Yvette (FR); Rainer Siebert, Villepreux (FR)

Correspondence Address: Blakely Sokoloff, Taylor & Zafman, 7th Floor, 12400 Wilshire Boulevard, Los Angeles, CA, 90025, US

(21) Appl. No.: 10/276,079

(22) PCT Filed: May 11, 2001
(86) PCT No.: PCT/FR01/01429

(30) Foreign Application Priority Data
May 15, 2000 (FR) 00 06138

(51) Int. Cl. G01N 27/27

(52) U.S. Cl. 204/453; 204/604

(57) ABSTRACT

A method of injecting a sample into an electrophoresis capillary, in which method the capillary (1) is plunged into the sample and an electric field is applied between the ends of the capillary (1) to cause the sample to migrate into the capillary (1), the method being characterized in that the sample is previously introduced into a part (3) presenting a channel (4) of dimensions perpendicular to the direction in which said channel (4) extends that are smaller than about four times the outside diameter of the capillary (1), and in that in order to plunge the capillary (1) into the sample, said capillary (1) is introduced into said channel (4).

The present invention relates to injecting a sample into an electrophoresis capillary.

Electrophoresis by capillary(ies) has the advantage of enabling throughput to be increased and automation to be more extensive than in prior electrophoresis techniques.

Nevertheless, that technique is very expensive, in particular when it comes to preparing samples.

The injection techniques mainly used at present require samples to be prepared that are of very large volume (10 microliters (μl) to 20 μl of a DNA sample, for example), with only a small portion thereof being used.

An object of the invention is to mitigate that drawback.

Another object of the invention is to propose a technique which makes it possible to perform reproducible and efficient electrokinetic injection into a capillary or a set of capillaries.

Two main different methods are known for injecting a sample such as a sample of DNA for example, into a capillary: hydrodynamic injection; and electrokinetic injection.

Hydrodynamic injection consists in using a pressure difference to cause a certain quantity of sample to enter into a capillary. That technique is often relatively unsatisfactory insofar as it requires large sample introduction zones and consequently does not make it possible to achieve good resolution, it can be used only for separation matrices of low viscosity, and it is difficult to implement in parallel on a plurality of capillaries.

That is why it is usually preferable to use electrokinetic injection which consists in applying a short-duration potential difference between the ends of capillaries in order to cause molecules to migrate inside them. The quantity of sample introduced by that method can be increased either by increasing the potential difference or by lengthening the loading time, even though the quantity injected is not fully under control. In general, resolution is better than it is for hydrodynamic injection.

The invention proposes a method of injecting a sample into an electrophoresis capillary, in which method the capillary is plunged into the sample and an electric field is applied between the ends of the capillary to cause the sample to migrate into the capillary, the method being characterized in that the sample is previously introduced into a part presenting a channel of dimensions perpendicular to the direction in which said channel extends that are smaller than about four times the outside diameter of the capillary, and in that in order to plunge the capillary into the sample, said capillary is introduced into said channel.

The invention also proposes a device for injecting a sample into an electrophoresis capillary, the device having a hollow part in which the sample is received and into which the capillary is to be plunged, and also having means for applying an electric field between the ends of the capillary to cause the sample to migrate into the capillary, the device being characterized in that said hollow part is a part presenting a channel which is of dimensions perpendicular to the direction along which said channel extends that are smaller than about four times the outside diameter of the capillary and which is adapted to receive a capillary, and in that the device also has means for introducing the sample into said channel.

With such a method or such a device, the volume of sample that needs to be prepared is considerably reduced: it suffices to use a volume of sample that is sufficient to fill the channel along a few millimeters (mm); use is then made of the entire prepared sample.

Furthermore, such a channel makes it possible to control accurately the position of the capillary and in particular makes it possible to position it very accurately relative to the electrode, thereby reproducibly creating an electric field for causing the sample to migrate.

In addition, it enables the field to be made to be very uniform at the inlet to the capillary, thereby obtaining the same migration speed for all of the molecules in the channel.

This improves the reproducibility and the effectiveness of injection.

The injection device proposed by the invention advantageously further comprises the following characteristics taken singly or in any feasible combination, which characteristics also contribute to achieving the objects of the invention:

the well-forming element and the part presenting the channel are suitable for engaging one in the other, the sample rising into the channel by capillarity or by pressure difference when the part presenting the channel is introduced into the well-forming part;

the well-forming element is flared in shape to facilitate guiding the part presenting a channel;

the channel is extended by a flared opening which facilitates introduction of the capillary;

said opening is substantially conical in shape;

the device includes a plate presenting a plurality of well-forming elements for co-operating with a plurality of complementary parts, each presenting a channel;

the device includes at least one receptacle suitable for receiving such a plate and means suitable for transporting said receptacle automatically from one workstation to another;

the device further comprises a lid suitable for closing the receptacle when such a plate is in place therein;

the device includes gasket-forming means providing sealing between the receptacle and the lid; and

the complementary parts each presenting a channel are carried by a plate, and in that it has means for automatically positioning said plate relative to the plate presenting a plurality of well-forming elements.

The invention also provides an electrophoresis device including such an injection device.

Other characteristics and advantages of the invention appear further from the following description which is purely illustrative and non-limiting and which should be read with reference to the accompanying drawings, in which:

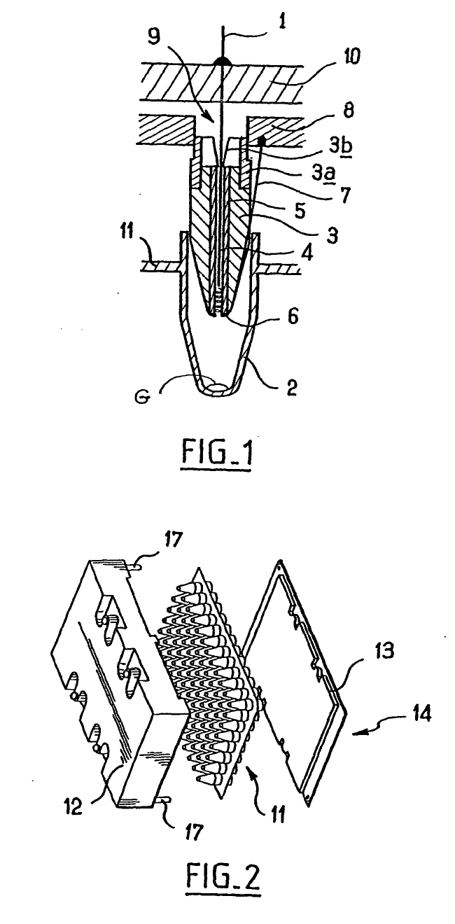

FIG. 1 is a diagrammatic section view of a device constituting a possible embodiment of the invention;

FIG. 2 is a diagrammatic exploded perspective view of a box for handling a device constituting an embodiment of the invention; and

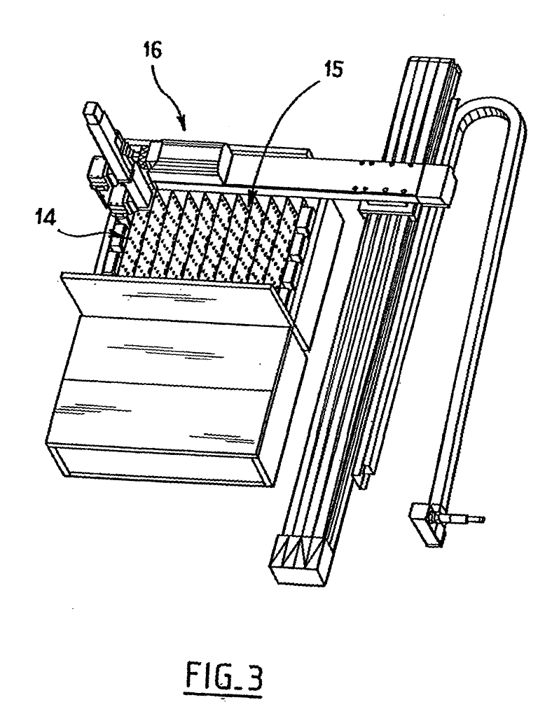

FIG. 3 is a diagrammatic perspective view of a storage enclosure of a device constituting a possible embodiment of the invention, together with automatic handling means.

FIG. 1 shows a system enabling samples to be injected into a capillary 1.

The system comprises a well 2 whose bottom is substantially conical in shape and receives a drop of a sample to be injected into the capillary. It also comprises a part 3 for inserting into the well 2, which part is of a shape that enables it to be nested in the well.

The part 3 presents a channel 4, in this case a tubular channel, which extends axially along its entire length and in which the capillary 1 is received.

More precisely, the channel 4 is defined by a tube 5 of glass or analogous material having a very small inside diameter and in which the capillary 1 is received.

At its end through which the sample is to be inserted into the tube 5, and then into the capillary 1, the part 3 carries an electrode 6.

This electrode 6 is powered by means of a wire 7 which extends along the height of the part 3 between said electrode 6 and a metal plate 8 which is itself connected to a high voltage generator.

The part 3 is fixed in an orifice 9 which passes through the plate 8, e.g. by screw-engagement.

In said orifice 9, the part 3 is terminated by a metal portion 3a (which is electrically conductive), having an axial opening 3b passing therethrough, said opening being conical in shape so as to enable it to guide the capillary and place it in the tube 5 (the walls of the opening are made of Teflon, for example).

The capillary 1 is carried by a plate 10 forming a support.

The above-described device is used to perform injection as follows.

A drop G of sample (i.e. a few μl, e.g. 1 μl to 5 μl) is placed in the bottom of the well 2, and then the part 3 is inserted into the well 2.

The drop G then rises by capillarity or pressure into the tube 5. A drop comprising a few micrometers of sample thus suffices to create a column of sample in the tube 5 over a height of several millimeters.

The capillary 1 is then inserted into the part 3 by bringing the support-forming plate 10 onto the plate 8.

The capillary 1 is then immersed in the sample, being situated at a well-determined and reproducible distance from the electrode 6.

The application of an electric field between the electrode 6 and another electrode (not shown) at the end of the capillary 1 that is remote from the electrode 6 serves to cause molecules to migrate into the capillary 1.

By way of example, the capillary 1 has a length of 35 centimeters (cm), an inside diameter of 75 micrometers (μm), and an outside diameter of 200 μm.

The part 3 and the plate 10 are made of Plexiglass, for example.

The well 2, the part 3, and the tube 5 have a height of 20 mm to 25 mm, for example.

The plate 8 is made of stainless steel, for example.

The inside diameter of the tube 5 is 650 μm and its outside diameter is 1600 μm, for example.

The inside diameter of the conical hole presented by the Teflon portion 3 varies over the range 1000 μm to 400 μm.

By way of example, the electrode 6 is made of platinum and is in the form of a disk having an inside diameter of 400 μm and an outside diameter of 700 μm, being fitted to the end edge of the part 3.

Naturally, other electrode dispositions could be envisaged.

In particular, the electrode 6 could be carried by the bottom of the well 2. It could be constituted by a wire, e.g. a platinum wire, going down from the plate 8 to the bottom of the well. The tube 5 may be made of platinum and act as an electrode.

In another variant, the part 2 could be a metal part constituting the electrode 6.

In all cases, it is advantageous for the electrode to be given a shape enabling an electric field that is as uniform as possible to be established in the channel 4.

The well 2 is advantageously carried by a plate 11, having a plurality of other injection wells.

By way of example, the plate 11 may carry 96 wells disposed in an 8×12 matrix.

As shown in FIG. 2, the plate 11 and the wells 2 carried thereby are advantageously received in a receptacle 12.

The receptacle 12 enables said plates 11 to be handled, and in particular it enables them to be transported from one workstation to another.

It includes keying means (pegs 17) ensuring that a plate 11 can be inserted in only one possible position in said receptacle 12.

A lid 13 is fitted onto said receptacle 12 so as to prevent the sample evaporating or being exposed to light.

Gasket-forming means are provided between said lid 13 and said receptacle 12 so as to minimize evaporation.

The boxes 14, each constituted in this way by a receptacle 12 closed by a lid 13 and containing a plate 11 enable a robot to handle the plates 11, as follows.

Once the wells 2 of the plate 11 have been filled initially, the robot or an operator puts the lid 13 into place on the receptacle 12 in which said plate 11 has been placed, thereby closing the receptacle 12.

Thereafter, the box 14 made up in this way is transported to an enclosure 15 (FIG. 3) in which it is possible to store a large number of these boxes 14.

By way of example, the cabinet 15 comprises a refrigerated compartment maintained permanently at 4° C. or lower, thus minimizing deterioration of the stored samples.

The device may also comprise a heater compartment enabling samples to be denatured, for example by being heated to 95° C., prior to being cooled quickly to 4° C. or lower, with the robot moving the boxes 14 from one compartment to another.

The heating compartment may be integrated within the cabinet 15, or it may be constituted by an independent workstation.

When electrophoresis is to be performed on a plate 11, the robot takes the box corresponding to said plate 11 from the refrigerated compartment of the cabinet 15 by means of a handling arm 16.

It removes the lid 13 and replaces it with a lid constituted by a plate of the same type as the plate 8, i.e. a plate carrying a plurality of electrode support parts 3, these parts being distributed over said plate 8 in such a manner as to corresponding to the various wells 2 of the plate 11.

The samples then rise by capillarity into the tubes 5 of the parts 3.

When the samples are thus in place in the tubes 5, the new box constituted by a receptacle 12, a plate 11, and a lid 8 carrying a plurality of electrode-support parts 3 is transported by the robot into the sequencer.

It is inserted therein moving parallel to the axis of the capillaries, which become inserted inside the tubes 5 of the parts 3, being guided by the conical openings of the portions 3a.

All of the capillaries are then positioned in the same manner relative to the electrodes 6, and this positioning is reproducible from one plate 11 to another.

1/ A method of injecting a sample into an electrophoresis capillary, in which method the capillary (1) is plunged into the sample and an electric field is applied between the ends of the capillary (1) to cause the sample to migrate into the capillary (1), the method being characterized in that the sample is previously introduced into a part (3) presenting a channel (4) of dimensions perpendicular to the direction in which said channel (4) extends that are smaller than about four times the outside diameter of the capillary (1), and in that in order to plunge the capillary (1) into the sample, said capillary (1) is introduced into said channel (4).

2/ A device for injecting a sample into an electrophoresis capillary (1), the device having a hollow part (3) in which the sample is received and into which the capillary (1) is to be plunged, and also having means for applying an electric field between the ends of the capillary (1) to cause the sample to migrate into the capillary (1), the device being characterized in that said hollow part (3) is a part presenting a channel (4) which is of dimensions perpendicular to the direction along which said channel (4) extends that are smaller than about four times the outside diameter of the capillary (1) and which is adapted to receive a capillary (1), and in that the device also has means for introducing the sample into said channel (4).

3/ A device according to claim 2, characterized in that the means for introducing a sample into the channel (4) comprises a well-forming element which is suitable for receiving the part (3) presenting the channel (4), with the bottom of the well being designed to receive a drop of sample.

4/ A device according to claim 3, characterized in that the well-forming element and the part (3) presenting the channel are suitable for engaging one in the other, the sample rising into the channel (4) by capillarity or by pressure difference when the part (3) presenting the channel (4) is introduced into the well-forming part.

5/ A device according to claim 4, characterized in that the well-forming element is flared in shape to facilitate guiding the part (3) presenting a channel (4).

6/ A device according to any one of claims 2 to 5, characterized in that the channel is extended by a flared opening which facilitates introduction of the capillary.

7/ A device according to claim 6, characterized in that said opening is substantially conical in shape.

8/ A device according to claim 3, taken on its own or in combination with any one of claims 4 to 7, characterized in that it includes a plate presenting a plurality of well-forming elements for co-operating with a plurality of complementary parts, each presenting a channel.

9/ A device according to claim 8, characterized in that it includes at least one receptacle suitable for receiving such a plate and means suitable for transporting said receptacle automatically from one workstation to another.

10/ A device according to claim 9, characterized in that it further comprises a lid suitable for closing the receptacle when such a plate is in place therein.

11/ A device according to claim 10, characterized in that it includes gasket-forming means providing sealing between the receptacle and the lid.

12/ A device according to any one of claims 8 to 10, characterized in that the complementary parts each presenting a channel are carried by a plate, and in that it has means for automatically positioning said plate relative to the plate presenting a plurality of well-forming elements.

13/ An electrophoresis device characterized in that it includes an injection device according to any one of claims 2 to 12.
